(19) United States
(12) Patent Application Publication
(10) Pub. No.: US 2005/0241165 A1
(43) Pub. Date: Nov. 3, 2005

(54) DEVICE FOR FACILTATING THE AIMING OF AN ANTENNA ENABLING SIGNALS TRANSMITTED BY ONE OR SEVERAL SATELITES TO BE PICKED UP

(76) Inventor: Gilles Ribatto, Chartrettes (FR)

Correspondence Address: Clark & Brody, Suite 600, 1750 K Street NW, Washington, DC, 20006, US

(21) Appl. No.: 10/515,140

(22) PCT Filed: May 20, 2003
(86) PCT No.: PCT/FR03/01510

§ 371 Date: Nov. 19, 2004

(30) Foreign Application Priority Data
May 21, 2002 (FR) 02/06145

(51) Int. Cl. G01C 17/14

(52) U.S. Cl. 33/349

(57) ABSTRACT

The invention relates to a device for facilitating the aiming of an antenna enabling signals transmitted by one or several satellites to be picked up, this device includes a compass, the body of which (3) is provided with an attachment system (5) on the antenna. According to the invention, the compass includes a dial onto which the magnetic south and the name of the satellites in their geographical position are transferred and in that the body (3) includes a mark (4) for aiming the antenna by simply rotating it in azimuth.

The present invention relates to a device which facilitates the aiming of an antenna or receiver in the general sense, such as a parabolic antenna enabling signals, for example radio and/or television signals, transmitted by one or several satellites to be picked up.

Aiming an antenna at one or several satellites is a difficult operation. Indeed, the elevation of the antenna (up/down adjustment) needs to be adjusted, and then the azimuth (left/right adjustment) with a high precision, in order to receive the signals transmitted by the aimed satellite(s) and thereby to be able to obtain images or sounds broadcasted by this (these) satellite(s).

All the television and/or radio programme broadcasting satellites are positioned eastwards or westwards from the geographical south. In order to aim an antenna at a satellite, this antenna already needs to be directed towards the south and then orientated to the left (if the aimed satellite is positioned eastwards) or to the right (if the aimed satellite is positioned westwards).

There are two kinds of radio/television signals transmitted by satellites: analog signals and digital signals.

In order to pick up analog signals, the antenna is connected to an analog demodulator itself connected to a TV set. In this case, upon aiming the antenna, it is sufficient, after having directed the latter towards the south, to rotate it slowly to the left or right. When the antenna picks up a signal transmitted by a satellite, an image will appear on the screen of the TV set, of course, provided that the demodulator is adjusted on a suitable channel and that the elevation of the antenna is correct, otherwise the antenna will never pick up any signal.

To pick up digital signals, the antenna is connected to a digital demodulator, itself connected to a TV set. Unlike the analog demodulator, by directing the antenna towards the south and rotating it slowly from left to right, it will not be possible to know whether the latter picks up a signal or not because for digital signals, a long time is required after receiving a signal for demodulating the latter (transformed into an image on the TV set). This time is variable according to the digital demodulator used. Moreover, the aiming precision for digital signals should be very high of the order of a few degrees. Consequently, many people never manage to aim their antenna with a digital demodulator and tend to bring back the equipment to their reseller, generating significant and unjustified returns to the after-sales service, endured by companies distributing this kind of products today.

To facilitate the aiming of an antenna at a satellite, the state of the art has suggested different solutions based on the use of a compass indicating magnetic south. Thus, for example, U.S. Pat. No. 5,274,926 describes an instrument for assisting the aiming of antennas, including a sphere to which a map is transferred, illustrating an area of the surface of the Earth, served by the satellite. This sphere is mounted onto a support equipped with a line of sight for the satellite and with a compass associated with a spirit level. To aim the line of sight of the instrument at the satellite, the sphere is displaced so as to superimpose a point of the compass with a point of the map illustrating the location where the instrument is used. It is clear that such an instrument can only have a very limited precision as the location where the instrument is used, is illustrated on a sphere which may only have a reduced size in practice.

Document DE 295 18 105 also describes a device for adjusting satellite antennas including a compass placed at the center of a disc on which position lines are illustrated for cities corresponding to the geographical application area of the satellite antenna. The disc includes a mark to be aligned with an arrow for locating the satellite, placed on the support of the antenna. The support of the antenna is pivoted so that the needle of the compass coincides with the position line bearing the name of the city where the antenna is used. It is clear that such a device is not universal because it requires the making of a great number of discs corresponding to different geographic areas.

Document JP 60 206 302 describes an aiming instrument for an antenna with the help of a spherical level with a hemispherical body illustrating a map and provided at its base with a passage window for the needle of a compass. Such an instrument also has a limited precision as the set-up site appears on a body with a very reduced size.

Document U.S. 2002/005,816 also relates to a device for alignment of satellite antennas, including a tubular fitting component on the support arm of the antenna. This tubular component is provided with a spirit level, a compass and a map able to show the angle along which the support for attaching the antenna is positioned on the arm in order to align the antenna. In addition to the fact that such a device requires localization of the compass at the focal point of the antenna, which disrupts its operation, such a device also has poor aiming precision by the positioning of a compass near a map.

The object of the invention is therefore directed to finding a remedy to the drawbacks of the prior art by providing a device for facilitating the aiming of an antenna, having good precision and quasi-universal use regardless of the set-up location of the antenna.

Another object of the invention is to provide a device for facilitating the aiming of an antenna, with a simple design and reduced costs.

To achieve such goals, the object of the invention relates to a device for facilitating the aiming of an antenna enabling signals transmitted by one or several satellites to be picked up, this device including a compass, the body of which is provided with an attachment system on the antenna.

According to the invention, the compass includes a dial onto which magnetic south and the name of the satellites at their geographical positions are transferred and the body includes a mark for aiming the antenna by having it simply rotate in azimuth.

The device according to the invention implements a (analog or digital) compass provided with an attachment system either by bonding and/or attaching with clips and/or snapping on and/or screwing and/or riveting and/or any other means making the device integral with the antenna.

For more ease, the device according to the invention is also called a pointer. The pointer may be attached in any location on an antenna, but it will preferably be attached onto the LNB, i.e. on the electronic head of the antenna or on the attachment bracket of the LNB.

Various other features will become apparent from the description made below with reference to the appended drawings which show embodiments of the object of the invention, as non-limiting examples.

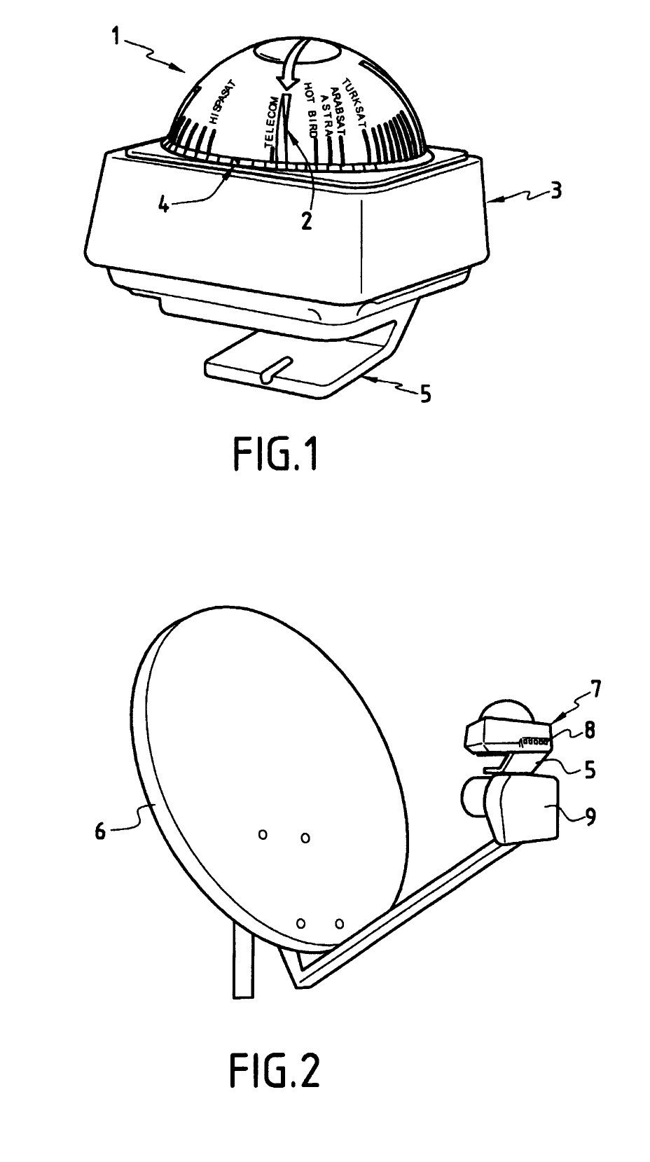

FIG. 1 is a perspective view of an alternative embodiment of the pointer according to the invention using a compass.

FIG. 2 illustrates a parabolic antenna, the electronic head of which is equipped with a pointer according to the invention.

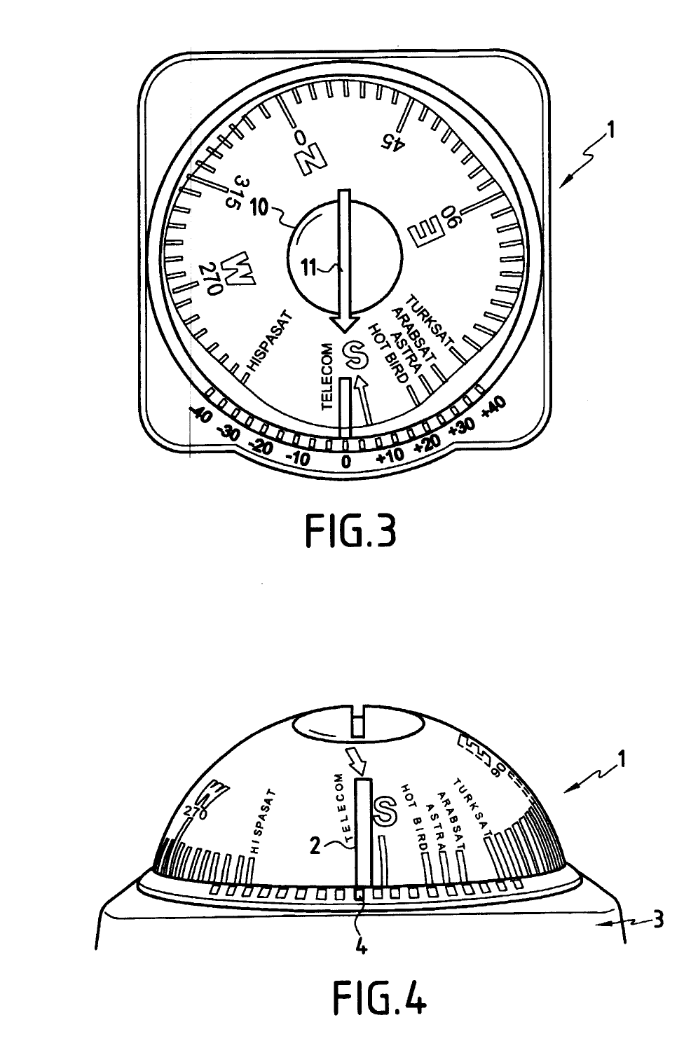

FIG. 3 is a top view of a pointer according to the invention using a compass.

FIG. 4 is a profile view of a pointer according to the invention using a compass.

As apparent in the figures, the device or the pointer 7 illustrated as using a compass, has a dome 1 including a dial for the compass and onto which the names of several, i.e., in the illustrated example six, radio/television program broadcasting satellites are printed or transferred. These names have been printed on either side of the magnetic south (represented with an S on FIG. 1 and FIG. 3) in their geographical positions. Conventionally, the dial of the compass is mobile so as to be locked on the Earth's magnetic axis. As apparent in the figures, the dial is visible through a dome of translucent material. The pointer thereby forms a spirit level with the presence of a liquid between the plastic dome and the dial which is made in a known way with a sphere, a part of which, the dome, is visible.

Preferably, the translucent material dome is provided with a mark 2, for example a white mark, used for aiming the antenna more particularly when applying a calibration or an adjustment related to the geographical set-up location. This mark 2 should be aligned (by rotating the antenna to the left or to the right) with the name of the aimed satellite. In FIG. 1, the mark 2 is aligned with the south, and the antenna therefore aims at the south. If the mark 2 is aligned with the Telecom lettering, the antenna 6 aims at the Telecom satellite.

The pointer has a body 3 from which the dome 1 rises. The body 3 has an aiming mark 4 for the antenna, for example a white mark in the illustrated example, located at the center (east/west) of the body. The body 3 is provided with an attachment system 5 on an antenna 6. In the illustrated example, the attachment system 5 is formed with a jointed tab on the body along an axis 8 allowing the compass to be always positioned horizontally. For example, the tab 5 may include an adhesive or self-adhesive means. Preferably, and as more specifically apparent in FIG. 2, the pointer 7 is adhered to the attachment bracket of the electronic head 9 (LNB) of the parabolic antenna 6, by means of tab 5.

As apparent in the example illustrated in FIG. 4, without any application of a geographical compensation, the mark 2 of the plastic dome is aligned with the mark 4 of the body of the pointer. Aiming the antenna at a satellite is achieved by simply rotating the antenna in azimuth so as to bring the satellite name borne by the dial in alignment with the mark 2 of the plastic dome, i.e., in the relevant example, with the aiming mark 4 borne by the body 3. In the example illustrated in FIGS. 3 and 4, the adjustment is made on the Telecom satellite.

According to a preferred alternative embodiment, the plastic dome may rotate or pivot over 360° relatively to the body 3 of the pointer, which allows a calibration of the pointer to be performed as explained above according to the geographical position of the installer (Portugal, Greece, etc.). According to this alternative, on either side of the mark 4 formed by the body 3, indicators or marks (not visible in FIG. 1) are positioned, for example every five degrees, both eastwards and westwards. Their role is to allow the pointer to be precisely calibrated by aligning the mark 2 with the indicator corresponding to the geographical offset of the installer. The antenna is rotated to the left or right so that the mark 2 becomes aligned with the name of the aimed satellite.

In order to adjust a satellite antenna 6, it is highly recommended to stand behind the latter so as to be able to pivot it in azimuth (left/right) easily. It is for this reason that it is preferable that the compass of the pointer be inverted by 180° relatively to the normal, so that the installer standing behind the antenna may directly read on the dial of the compass the aimed direction during the aiming. Without this, one would have to move round the antenna in order to find out what the compass is showing.

According to another feature of the invention more particularly illustrated in FIG. 3, the pointer using a compass includes a spirit level 10 visible through the transparent dome which is provided with a mark 11, for example a white mark. This mark 11 should be aligned with the spirit level in both axes in order to guarantee that the attachment of the antenna is level and to facilitate the horizontal adjustment of the pointer.

The invention is not limited to the described and illustrated examples since various changes may be made thereto without departing from its scope.

1. A device for facilitating the aiming of an antenna (6) allowing signals transmitted by one or several satellites to be picked up, this device including a compass, the body (3) of which is provided with an attachment system (5) on the antenna, wherein the compass includes a dial on which the magnetic south and the name of the satellites at their geographical position, having been transferred and in that the body (3) includes a mark (4) for aiming the antenna by simply rotating it in azimuth.

2. The device according to claim 1, wherein the compass includes a dial embodied by the body (3) or an annulus or ring.

3. The device according to claim 1, wherein the compass includes a dial embodied by a dome.

4. The device according to claim 1, wherein it includes a mark which may rotate relatively to the body (3) over a range of 360° in order to compensate the geographical offset of a satellite relatively to the magnetic south according to the geographical position of the installer.

5. The device according to claim 3, wherein it includes a translucent dome provided at its top with a mark (11) allowing the use of a spirit level (10) for checking the horizontality of the compass.

6. The device according to claim 5, wherein the translucent dome is provided with a mark (2) and may rotate relatively to the body (3).

7. The device according to claim 1, wherein the mark (4) for aiming the antenna includes on either side, eastwards and westwards, marks, for example positioned every five degrees, in order to align the mark (2) of the translucent dome with one of said marks corresponding to the geographical offset of the installer.

8. The device according to claim 1, wherein it includes a jointed attachment tab (5) on the body allowing the elevation of the antenna to be compensated by providing horizontal positioning of the dome.

9. The device according to claim 1, wherein the compass is inverted by 180° relatively to the normal direction so that in the mounted position on the electronic head of the antenna, the aimed direction during the aiming may be directly read on the dial.

10. The device according to claim 2, wherein it includes a mark which may rotate relatively to the body (3) over a range of 360° in order to compensate the geographical offset of a satellite relatively to the magnetic south according to the geographical position of the installer.

11. The device according to claim 3, wherein it includes a mark which may rotate relatively to the body (3) over a range of 360° in order to compensate the geographical offset of a satellite relatively to the magnetic south according to the geographical position of the installer.

12. The device according to claim 6, wherein the mark (4) for aiming the antenna includes on either side, eastwards and westwards, marks, for example positioned every five degrees, in order to align the mark (2) of the translucent dome with one of said marks corresponding to the geographical offset of the installer.
